(19) United States
(12) Patent Application Publication
(10) Pub. No.: US 2011/0227958 A1
(43) Pub. Date: Sep. 22, 2011

(54) FLAT PANEL DISPLAY APPARATUS AND METHOD OF COMPENSATING FOR DARK SPOTS THEREOF

(75) Inventors: Soon-Ryong PARK, Yongin-city (KR); Woo-Suk JUNG, Yongin-city (KR); Seung-Jae JEONG, Yongin-city (KR); Duk-Jin LEE, Yongin-city (KR); Gi-Na YOO, Yongin-city (KR); Min-Jae KIM, Yongin-city (KR); Sa-Bang UM, Yongin-city (KR); Ii-Ryong CHO, Yongin-city (KR); Jae-Yong KIM, Yongin-city (KR); Noh-Min KWAK, Yongin-city (KR)

(73) Assignee: SAMSUNG MOBILE DISPLAY CO., LTD., Yongin-city (KR)

(21) Appl. No.: 12/973,700

(22) Filed: Dec. 20, 2010

(30) Foreign Application Priority Data
Mar. 16, 2010 (KR) 10-2010-0023397

(51) Int. Cl. G09G 5/10; G09G 3/36

(52) U.S. Cl. 345/690; 345/88

(57) ABSTRACT

A flat panel display apparatus capable of preventing a reduction in yield due to dark spots thereof, and a method of compensating for the dark spots are disclosed. The apparatus includes: a display unit including a plurality of pixels, each pixel including a subpixel of a first color, a subpixel of a second color and a subpixel of third color, where the first color, the second color and the third color are different from each other; an image signal input unit; a dark spot detection unit configured to detect a color and location of a dark spot subpixel that comprises a dark spot; a neighboring subpixel detection unit configured to identify location of one or more neighboring same color subpixels that are adjacent to the dark spot subpixel and having the same color as the dark spot subpixel; a luminance detection unit configured to detect a luminance of the one or more neighboring same color subpixels; and a control unit configured to coordinate increasing the luminance of all or a subset of the one or more neighboring same color subpixels.

### CROSS-REFERENCE TO RELATED APPLICATIONS

This application claims the benefit of Korean Patent Application No. 10-2010-0023397, filed on Mar. 16, 2010, in the Korean Intellectual Property Office, the disclosure of which is incorporated herein in its entirety by reference.

### BACKGROUND

1. Field

The disclosure relates to a flat panel display apparatus capable of preventing a reduction in yield due to dark spots thereof and a method of compensating for dark spots.

2. Description of the Related Technology

Flat panel display apparatuses such as organic light emitting display apparatuses and liquid crystal display (LCD) apparatuses may be formed to be light, thin and flexible, and are widely used.

One factor that influences a yield rate of flat panel display apparatuses is the presence of dark spots.

A dark spot is a subpixel that does not emit light because, for example, fine dust or an impurity was inadvertently inserted while the subpixel was being manufactured or because a pixel circuit has a defect. If the number of dark spots in a whole display area is about two or three, a flat panel display apparatus may be regarded as a normal product. However, if the number of dark spots is greater than that, the flat panel display apparatus may be regarded as being defective.

Although process management is performed using various methods in order to reduce dark spot defects, the reduction in dark spot defects by performing process management is restrictive.

An organic film deposition process is typically performed multiple times to form an organic light emitting display apparatus, and thus the possibility of having dark spots may be higher in organic light emitting display apparatuses than with LCD apparatuses.

### SUMMARY OF CERTAIN INVENTIVE ASPECTS

Embodiments of the present invention include a flat panel display apparatus capable of preventing a reduction in yield due to dark spots thereof, and a method of compensating for the dark spots.

Additional aspects will be set forth in part in the description which follows and, in part, will be apparent from the description, or may be learned by practice of the presented embodiments.

One aspect is a flat panel display apparatus including: a display unit including a plurality of pixels, each pixel including a subpixel of a first color, a subpixel of a second color and a subpixel of third color, where the first color, the second color and the third color are different from each other, an image signal input unit, a dark spot detection unit configured to detect a color and location of a dark spot subpixel that includes a dark spot, a neighboring subpixel detection unit configured to identify location of one or more neighboring same color subpixels that are adjacent to the dark spot subpixel and having the same color as the dark spot subpixel, a luminance detection unit configured to detect a luminance of the one or more neighboring same color subpixels, and a control unit configured to coordinate increasing the luminance of all or a subset of the one or more neighboring same color subpixels.

The subpixels may be arranged in an order of the first color, the second color and the third color in the first direction.

The subpixels having the same color may be arranged in a second direction perpendicular to the first direction.

The plurality of pixels may include a first pixel and a second pixel that are adjacent to each other in the first direction, where the subpixels of the first pixel may be arranged in an order of the first color, the second color and the third color in the first direction, and where the subpixels of the second pixel may be arranged in an order of the third color, the second color and the first color in the first direction.

The subpixels having the same color may be arranged in a second direction perpendicular to the first direction.

The plurality of pixels may include a first pixel and a second pixel that are adjacent to each other in a second direction perpendicular to the first direction, where the subpixels of the first pixel may be arranged in an order of the first color, the second color and the third color in the first direction, and where the subpixels of the second pixel may be arranged in an order of the third color, the first color and the second color in the first direction.

The neighboring same color subpixels may include subpixels that are immediately next to the dark spot subpixel along directions of data lines and scan lines, and may further include subpixels that are immediately diagonally next to the dark spot subpixel.

The control unit may further be configured to select the subset of the one or more neighboring same color subpixels for increasing luminance thereof

The control unit may further be configured to identify a geometric pattern of the one or more neighboring same color subpixels.

All or the subset of the one or more neighboring same color pixels may be preselected in the geometric pattern of the neighboring same color subpixels.

The control unit may further be configured to select all or the subset of the one or more neighboring same color subpixel using the geometric pattern and further using predetermined rules.

Another aspect is a method of compensating for a dark spot of a flat panel display apparatus, the method including: providing a display unit having an array of pixels, where each of the pixels includes a subpixel of a first color, a subpixel of a second and a subpixel of a third color, detecting the color and location of a dark spot subpixel that includes a dark spot, identifying a location of one or more neighboring same color subpixels that are adjacent to the dark spot subpixel and having the same color as the dark spot subpixel, detecting a luminance of the one or more neighboring same color subpixels, adjusting the luminance of all or a subset of the one or more of the neighboring same color subpixels to a luminance level that is higher than the detected luminance.

The subpixels may be arranged in an order of the first color, the second color and the third color in the first direction and the subpixels having the same color may be arranged in a second direction perpendicular to the first direction.

The plurality of pixels may include a first pixel and a second pixel that are adjacent to each other in the first direction, where the subpixels of the first pixel may be arranged in an order of the first color, the second color and the third color in the first direction, and where the subpixels of the second pixel may be arranged in an order of the third color, the second color and the first color in the first direction.

The subpixels having the same color may be arranged in a second direction perpendicular to the first direction, in all of the plurality of pixels.

The plurality of pixels may include a first pixel and a second pixel that are adjacent to each other in a second direction perpendicular to the first direction, where the subpixels of the first pixel may be arranged in an order of the first color, the second color and the third color in the first direction, and where the subpixels of the second pixel may be arranged in an order of the third color, the first color and the second color in the first direction.

Adjusting may include selecting all or the subset of the one or more of neighboring same color subpixels.

Selecting may include identifying a geometric pattern of the one or more neighboring same color subpixels.

All or the subset may be preselected in the identified geometric pattern.

Selecting of all or the subset may be made within the identified geometric pattern in accordance with a predetermined rule.

As neighboring subpixels being adjacent to and having the same color as a subpixel that is a dark spot have a high luminance, a viewer may not visually recognize the subpixel that is a dark spot.

Accordingly, a flat panel display apparatus may not be regarded as being defective even when the number of dark spots is greater than in a general case, and thus a yield rate may be increased.

### BRIEF DESCRIPTION OF THE DRAWINGS

These and/or other aspects will become apparent and more readily appreciated from the following description of certain embodiments, taken in conjunction with the accompanying drawings of which:

FIG. 1 is a block diagram of an embodiment of a flat panel display apparatus;

FIG. 2 is a flowchart of an embodiment of a method of compensating for a dark spot of an embodiment of a flat panel display apparatus;

FIG. 3 is a plan view showing an embodiment of an arrangement of subpixels of a display unit of an embodiment of a flat panel display apparatus;

FIG. 4 is a plan view showing another embodiment of an arrangement of subpixels of a display unit of an embodiment of a flat panel display apparatus; and

FIG. 5 is a plan view showing another embodiment of an arrangement of subpixels of a display unit of an embodiment of a flat panel display apparatus.

### DETAILED DESCRIPTION OF CERTAIN INVENTIVE EMBODIMENTS

Reference will now be made in detail to certain embodiments illustrated in the accompanying drawings, wherein like reference numerals generally refer to like elements throughout. Embodiments may have different forms and should not be construed as being limited to the descriptions set forth herein. Accordingly, the embodiments are merely described below, by referring to the figures, to explain aspects of the present description.

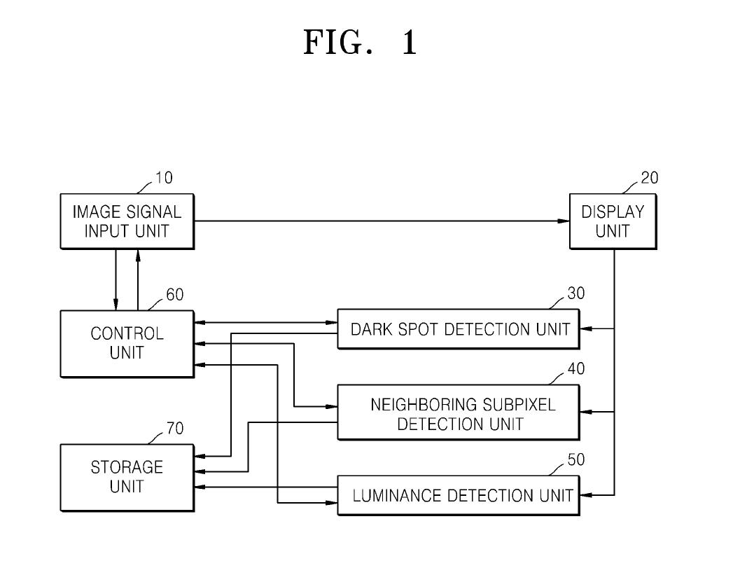

FIG. 1 is a block diagram of an embodiment of a flat panel display apparatus.

Referring to FIG. 1, an embodiment of the flat panel display apparatus includes an image signal input unit 10, a display unit 20, a dark spot detection unit 30, a neighboring subpixel detection unit 40, a luminance detection unit 50, a control unit 60 and a storage unit 70.

In general the word “unit,” as used herein, refers to logic embodied in hardware or firmware or to a collection of software instructions, having entry and exit points. In one embodiment, units may be written in a program language, such as JAVA, C or C++, or the like. In some embodiments, software units may be compiled or linked into an executable program, installed in a dynamic link library. In other embodiments, software units may be written in an interpreted language such as BASIC letters, PERL, LUA, or Python. In various embodiments, software units may be called from other units or from themselves, and/or may be invoked in response to detected events or interruptions. In some embodiments, units implemented in hardware may include connected logic units such as gates and flip-flops, and/or may include programmable units, such as programmable gate arrays or processors.

Generally, the units described herein refer to logical units that may be combined with other units or divided into sub-units despite their physical organization or storage. The units are executed by one or more computing systems, and may be stored on or within any suitable computer readable medium, or implemented in-whole or in-part within special designed hardware or firmware in various embodiments.

In some embodiments, the image signal input unit 10 receives an image signal from various external devices. In other embodiments, if a tuner is embedded, the image signal may be received wirelessly or via wires. In the embodiment of FIG. 1, the image signal is a modulated and compressed image signal.

In the embodiment of FIG. 1, the image signal input unit 10 demodulates and decompresses the image signal, and performs various types of image processing to control colors, brightness, size, and the like in order to display a predetermined image on a screen of the display unit 20.

The display unit 20 displays an image to a viewer by using the image signal processed by the image signal input unit 10.

The display unit 20 includes a plurality of pixels, each pixel including subpixels having a first color, a second color and a third color. In one embodiment, the first color may be red, the second color may be green, and the third color may be blue.

The display unit 20 may include various flat display panels such as a liquid crystal display (LCD) panel or an organic light emitting display panel.

The dark spot detection unit 30 generates a first detection signal by detecting a color and location of a subpixel that is a dark spot, from among the subpixels of the display unit 20, and transmits the first detection signal to the control unit 60 and/or the storage unit 70. The storage unit 70 stores the first detection signal.

The neighboring subpixel detection unit 40 generates a second detection signal by detecting locations of any neighboring subpixels that are adjacent to and have the same color as the subpixel that is a dark spot, and transmits the second detection signal to the control unit 60 and/or the storage unit 70. The storage unit 70 stores the second detection signal.

The luminance detection unit 50 generates a first luminance signal by detecting a first luminance of the neighboring subpixels adjacent to the subpixel that is a dark spot, and transmits the first luminance signal to the control unit 60 and/or the storage unit 70. The storage unit 70 stores the first luminance signal. The first luminance corresponds to a luminance value of the neighboring subpixels when in a normal state.

The control unit 60 selects a subset of the neighboring subpixels adjacent to and having the same color as the dark spot subpixel, and generates a second luminance signal corresponding to a second luminance that is higher than the first luminance of the selected neighboring subpixels, by using the first detection signal, the second detection signal and the first luminance signal, and transmits the second luminance signal to the image signal input unit 10 and/or the storage unit 70. The storage unit 70 stores the second luminance signal.

In some embodiments, the selection of the subset of neighboring subpixels by the control unit 60 may be based on a geometric pattern of the neighboring subpixels adjacent to and having the same color as the dark spot subpixel. Each subpixel of the display unit may be surrounded by subpixels of different colors in a variety of geometric patterns. For example, in one pattern, a red subpixel, which may be a dark spot, in a position (2, 2) of a 3×3 array may be surrounded by a green subpixel at position (1, 1), a blue subpixel at position (1, 2), a red subpixel at position (1, 3), a green subpixel at position (2, 1), a blue subpixel at position (2, 3), a green subpixel at position (3, 1), a blue subpixel at position (3, 2) and a red subpixel at position (3, 3). In this pattern, the neighboring subpixels adjacent to and having the same color as the dark spot subpixel may be the red subpixels at positions (1, 3) and (3, 3). In one embodiment, the control unit 60 may select the subpixel at position (1, 3) for this pattern, based on a predetermined rule which may be to select the subpixel(s) with the lower x coordinates in any given pattern. In another embodiment, the control unit 60 may select the subpixel (3, 3) for this specific pattern. In other embodiments, the control unit 60 may select one or more of the subpixels at positions (1, 3) and (3, 3) for this pattern. In yet other embodiments, the control unit 60 may select one or more of the subpixels at positions (1, 3) and (3, 3) based on other predetermined rules.

The image signal input unit 10 receives the second luminance signal from the control unit 60 and sends a signal to selected neighboring subpixels of the display unit 20 to adjust the second luminance.

With the selected neighboring subpixels having the same color as a subpixel that is a dark spot having a higher luminance, a viewer may not visually recognize the subpixel that is a dark spot.

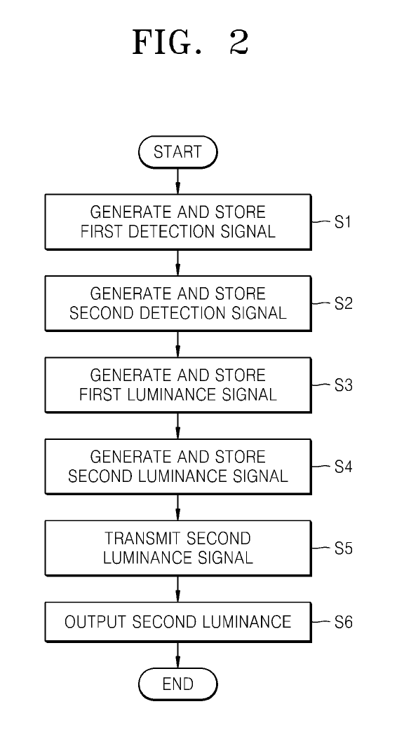

FIG. 2 is a flowchart of an embodiment of a method of compensating for a dark spot of an embodiment of a flat panel display apparatus.

Referring to FIGS. 1 and 2, the image signal input unit 10 receives an image signal from various external audio/video (AV) devices, demodulates and decompresses the image signal, and performs various types of image processing to control colors, brightness, size, and the like in order to display a predetermined image. The display unit 20 performs general image processing, e.g., displays an image to a viewer by using the image signal processed by the image signal input unit 10.

The dark spot detection unit 30 generates a first detection signal by detecting a certain subpixel of the display unit 20, which is a dark spot, and transmits the first detection signal to the storage unit 70 in order for the first detection signal to be stored (S1). The dark spot detection unit 30 also transmits the first detection signal to the control unit 60.

The neighboring subpixel detection unit 40 generates a second detection signal by detecting all neighboring subpixels adjacent to the subpixel that is a dark spot, and transmits the second detection signal to the storage unit 70 in order for the second detection signal to be stored (S2). The neighboring subpixel detection unit 40 also transmits the second detection signal to the control unit 60. As described above in relation to FIG. 1, the neighboring subpixels detected have the same color as the subpixel that is a dark spot.

The neighboring subpixel detection unit 40 may receive information regarding the subpixel that is a dark spot from the control unit 60 in response to the first detection signal and may detect the neighboring subpixels adjacent to the subpixel that is a dark spot.

The luminance detection unit 50 generates a first luminance signal by detecting a first luminance of the neighboring subpixels in a current state, and transmits the first luminance signal to the storage unit 70 in order for the first luminance signal to be stored (S3). The luminance detection unit 50 also transmits the first luminance signal to the control unit 60.

The control unit 60 sends a command to the luminance detection unit 50 to detect the first luminance of the neighboring subpixels in response to the second detection signal received by the neighboring subpixel detection unit 40.

The control unit 60 selects a subset of the neighboring subpixels adjacent to and having the same color as the dark spot subpixel, and generates a second luminance signal that corresponds to a second luminance that is higher than the first luminance of the neighboring subpixels, and transmits the second luminance signal to the storage unit 70 in order for the second luminance signal to be stored (S4).

The control unit 60 transmits the second luminance signal to the image signal input unit 10 (S5) such that the image signal input unit 10 sends a command to the selected neighboring subpixels of the display unit 20 to achieve the second luminance sent by the control unit 60 (S6).

A subpixel that is a dark spot is detected and then at least a subset of neighboring subpixels having the same color as the subpixel that is a dark spot are controlled to achieve a higher luminance. Consequently, a viewer may not recognize the subpixel that is a dark spot as a dark spot.

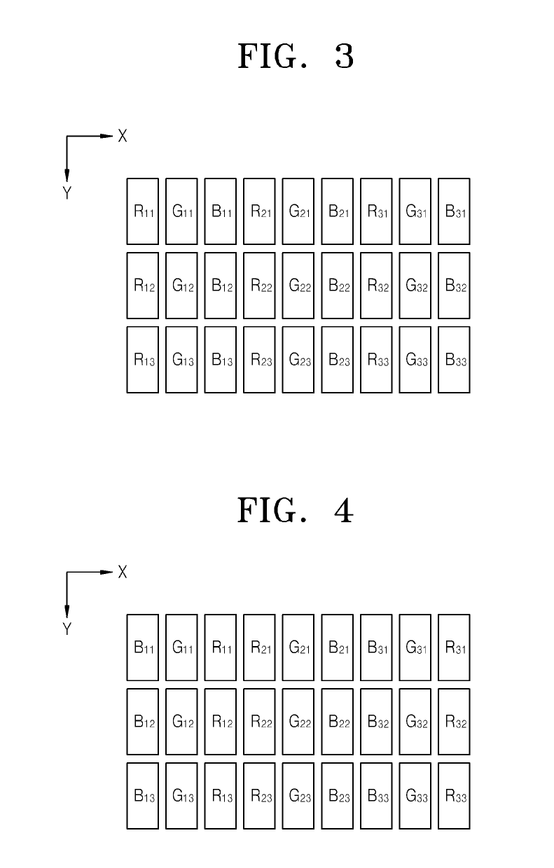

As shown in FIG. 3, red R, green G and blue B subpixels may be sequentially arranged in a first direction X and the subpixels may be arranged in the same sequence in subsequent rows.

In the embodiment of FIG. 3, if a red subpixel R₂₂ at a location (2,2) is a dark spot, the neighboring subpixel detection unit 40 detects a red subpixel R₂₁ at a location (2,1) and a red subpixel R₂₃ at a location (2,3), which are adjacent to the red subpixel R₂₂. The luminance detection unit 50 detects a first luminance of the red subpixels R₂₁ and R₂₃ in a current state, and the control unit 60 may select both subpixels and may instruct the image signal input unit 10 to adjust the red subpixels R₂₁ and R₂₃ to achieve a second luminance that is higher than the first luminance. Consequently, when an image is displayed, the image signal input unit 10 inputs an image signal such that the red subpixels R₂₁ and R₂₃ emit light of the higher luminance. In another embodiment, and the control unit 60 may select red subpixels other than the red subpixels R₂₁ and R₂₃.

In the embodiment shown in FIG. 4, red R, green G, blue B, blue B, green G and red R subpixels may be sequentially arranged in the first direction X and the subpixels may be arranged in the same sequence in the subsequent rows.

In the embodiment of FIG. 4, a pixel in which subpixels are arranged in an order of red R, green G and blue B and a pixel in which subpixels are arranged in an order of blue B, green G and red R are adjacent to each other in the first direction X.

If a red subpixel R₂₂ at a location (2,2) is a dark spot, the neighboring subpixel detection unit 40 may detect a red subpixel R₁₁ at a location (1,1), a red subpixel R₂₁ at a location (2,1), a red subpixel R₁₂ at a location (1,2), R₁₃ a red subpixel at location (1,3) and a red subpixel R₂₃ at a location (2,3), which are adjacent to the red subpixel R₂₂. The luminance detection unit 50 detects a first luminance of the red subpixels R₁₁, R₂₁ R₁₂, R₁₃ and R₂₃ in a current state, and the control unit 60 may, in one embodiment, select the red subpixels R₁₂, R₂₁ and R₂₃ based on the pattern of the neighboring subpixels or based on a predetermined rule, and may instruct the image signal input unit 10 to adjust the red subpixels R₁₂, R₂₁ and R₂₃ to achieve a luminance that is higher than the detected luminance. Consequently, when an image is displayed, the image signal input unit 10 inputs an image signal such that the red subpixels R₁₂, R₂₁ and R₂₃ emit light of the higher luminance. In such an embodiment, since three selected neighboring subpixels adjacent to a subpixel that is a dark spot have a higher luminance, an effect of covering a dark spot may be greater than in the embodiment of FIG. 3. In this embodiment, green G subpixels are compensated by neighboring subpixels arranged in the second direction Y.

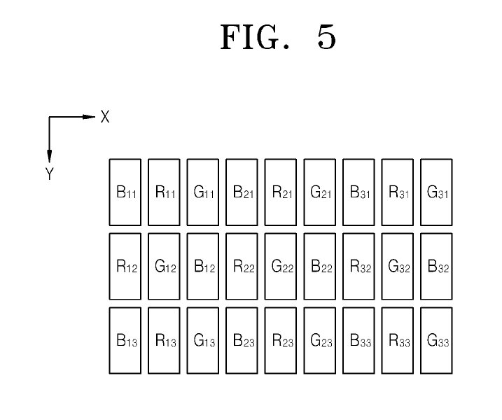

In the embodiment of FIG. 5, blue B, red R and green G subpixels are sequentially arranged in pixels of odd-number rows in the first direction X and red R, green G and blue B subpixels are arranged in pixels of even-number rows in the first direction X, wherein the pixels of the odd-number rows and the pixels of the even-number rows are adjacent to each other in the second direction Y.

If a red subpixel R₂₂ at a location (2,2) is a dark spot, the neighboring subpixel detection unit 40 may detect a red subpixel R₁₁ at a location (1,1), a red subpixel R₁₃ at a location (1,3), a red subpixel R₃₁ at a location (3,1) and a red subpixel R₃₃ at a location (3,3), which are adjacent to the red subpixel R₂₂. The luminance detection unit 50 detects a luminance of the red subpixels R₁₁, R₁₃, R₂₁ and R₂₃ in a current state, and the control unit 60 may, in one embodiment, select the red subpixels R₁₁, R₁₃, R₂₁ and R₂₃ based on the geometric pattern of neighboring subpixels of the same color as the dark spot, and/or based on a predetermined rule, and may send a command to the image signal input unit 10 to adjust the red subpixels R₁₁, R₁₃, R₂₁ and R₂₃ to achieve a luminance that is higher than the detected luminance. Consequently, when an image is displayed, the image signal input unit 10 inputs an image signal such that the selected red subpixels R₁₁, R₁₃, R₂₁ and R₂₃ emit light of the higher luminance. In such an embodiment, since four selected neighboring subpixels adjacent to a subpixel that is a dark spot have a higher luminance, an effect of covering a dark spot may be greater than the embodiment shown in FIG. 3.

Various units of the above-described embodiments of a flat panel display apparatus may not be integrated with the flat panel display apparatus in other embodiments. In some embodiments, the dark spot detection unit 30, the neighboring subpixel detection unit 40 and the luminance detection unit 50 may be distinct from the flat panel display apparatus and may only be only when the flat panel display apparatus performs detection.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A flat panel display apparatus comprising:
a display unit comprising a plurality of pixels, each pixel comprising a subpixel of a first color, a subpixel of a second color and a subpixel of third color, wherein the first color, the second color and the third color are different from each other;
an image signal input unit;
a dark spot detection unit configured to detect a color and location of a dark spot subpixel that comprises a dark spot;
a neighboring subpixel detection unit configured to identify location of one or more neighboring same color subpixels that are adjacent to the dark spot subpixel and having the same color as the dark spot subpixel;
a luminance detection unit configured to detect a luminance of the one or more neighboring same color subpixels; and
a control unit configured to coordinate increasing the luminance of all or a subset of the one or more neighboring same color subpixels.

2. The apparatus of claim 1, wherein the subpixels are arranged in an order of the first color, the second color and the third color in the first direction.

3. The apparatus of claim 2, wherein the subpixels having the same color are arranged in a second direction perpendicular to the first direction.

4. The apparatus of claim 1, wherein the plurality of pixels comprise a first pixel and a second pixel that are adjacent to each other in the first direction, wherein the subpixels of the first pixel are arranged in an order of the first color, the second color and the third color in the first direction, and wherein the subpixels of the second pixel are arranged in an order of the third color, the second color and the first color in the first direction.

5. The apparatus of claim 4, wherein the subpixels having the same color are arranged in a second direction perpendicular to the first direction.

6. The apparatus of claim 1, wherein the plurality of pixels comprise a first pixel and a second pixel that are adjacent to each other in a second direction perpendicular to the first direction,
wherein the subpixels of the first pixel are arranged in an order of the first color, the second color and the third color in the first direction, and
wherein the subpixels of the second pixel are arranged in an order of the third color, the first color and the second color in the first direction.

7. The apparatus of claim 1, wherein the neighboring same color subpixels comprise subpixels that are immediately next to the dark spot subpixel along directions of data lines and scan lines, and further comprises subpixels that are immediately diagonally next to the dark spot subpixel.

8. The apparatus of claim 1, wherein the control unit is further configured to select the subset of the one or more neighboring same color subpixels for increasing luminance thereof

9. The apparatus of claim 1, wherein the control unit is further configured to identify a geometric pattern of the one or more neighboring same color subpixels.

10. The apparatus of claim 1, wherein all or the subset of the one or more neighboring same color pixels is preselected in the geometric pattern of the neighboring same color subpixels.

11. The apparatus of claim 1, wherein the control unit is further configured to select all or the subset of the one or more neighboring same color subpixel using the geometric pattern and further using predetermined rules.

12. A method of compensating for a dark spot of a flat panel display apparatus, the method comprising:
providing a display unit having an array of pixels, wherein each of the pixels comprises a subpixel of a first color, a subpixel of a second and a subpixel of a third color;
detecting the color and location of a dark spot subpixel that comprises a dark spot;
identifying a location of one or more neighboring same color subpixels that are adjacent to the dark spot subpixel and having the same color as the dark spot subpixel;
detecting a luminance of the one or more neighboring same color subpixels;
adjusting the luminance of all or a subset of the one or more of the neighboring same color subpixels to a luminance level that is higher than the detected luminance.

13. The method of claim 12, wherein the subpixels are arranged in an order of the first color, the second color and the third color in the first direction and the subpixels having the same color are arranged in a second direction perpendicular to the first direction.

14. The method of claim 12, wherein the plurality of pixels comprise a first pixel and a second pixel that are adjacent to each other in the first direction,
wherein the subpixels of the first pixel are arranged in an order of the first color, the second color and the third color in the first direction, and
wherein the subpixels of the second pixel are arranged in an order of the third color, the second color and the first color in the first direction.

15. The method of claim 14, wherein the subpixels having the same color are arranged in a second direction perpendicular to the first direction, in all of the plurality of pixels.

16. The method of claim 12, wherein the plurality of pixels comprise a first pixel and a second pixel that are adjacent to each other in a second direction perpendicular to the first direction,
wherein the subpixels of the first pixel are arranged in an order of the first color, the second color and the third color in the first direction, and
wherein the subpixels of the second pixel are arranged in an order of the third color, the first color and the second color in the first direction.

17. The method of claim 12, wherein adjusting comprises selecting all or the subset of the one or more of neighboring same color subpixels.

18. The method of claim 17, wherein selecting comprises identifying a geometric pattern of the one or more neighboring same color subpixels.

19. The method of claim 12, wherein all or the subset is preselected in the identified geometric pattern.

20. The method of claim 17, wherein selecting of all or the subset is made within the identified geometric pattern in accordance with a predetermined rule.
